(19) United States
(12) Patent Application Publication
(10) Pub. No.: US 2005/0274414 A1
(43) Pub. Date: Dec. 15, 2005

(54) Drain device for high negative pressure exhaust system

(76) Inventors: Po-Sung Kuo, Sinying City (TW); Yung-Dar Chen, Baoshan Hsiang (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/865,014

(22) Filed: Jun. 10, 2004

(51) Int. Cl. G05D 7/01

(52) U.S. Cl. 137/204

(57) ABSTRACT

A drain device for removing solvent condensed in a depressed portion of an exhaust pipe. The drain device comprises a drain pipe connected to the depressed portion of the exhaust pipe. A first and second gate disposed therein form a buffer space therebetween. The first gate is near the inlet of the drain pipe. A needle valve communicated with the buffer space and the outlet, balances pressure therebetween. When a first amount of solvent accumulates in the depressed portion, the first gate opens briefly, allowing solvent to enter the buffer space. When a second amount of solvent accumulates in the buffer space, the second gate opens briefly, allowing solvent to drain from the outlet.

### BACKGROUND OF THE INVENTION

1. Field of the Invention

The present invention relates to a drain device, and in particular to a drain device for high negative pressure exhaust systems.

2. Description of the Related Art

Integrated circuit manufacturing involves depositing films and forming circuit patterns thereon with photoresist materials through photolithography, etching and stripping photoresist masks. Each of these steps, particularly the photoresist stripping step, produces abundant organic, metal, and other circuit-contamination sources.

Various toxic chemicals, including solvents and organic compounds, are produced during semiconductor and integrated circuit manufacturing operations and released into an exhaust system. Semiconductor manufacturers have used various methods to reduce emissions of organic materials, including incinerators, water scrubbers and adsorption systems. When passing through the exhaust system, vaporized solvents and organic compounds, however, may condense and accumulate in pipes thereof, which may increase the possibility of explosions. Thus, the removal of condensed solvents and organic compounds from pipes of an exhaust system is a critical issue for semiconductor manufactures.

In U.S. Pat. No. 5,427,610, Crocker teaches a modified photoresist solvent fume exhaust scrubber. In U.S. Pat. No. 6,391,621, Naruse teaches a process for the treatment of organic gas components in exhaust gas. Prior or subsequent to passing through the above apparatuses, however, residual solvents may condense in pipes, causing risk control problems.

Furthermore, FIG. 1 shows a U-trap used in a conventional high negative pressure exhaust system. The symbol “f” represents exhaust flow direction. The U-trap 10 is connected to a depressed portion 3 of an exhaust pipe 1 to drain condensed solvents 5 accumulated therein. The residual solvents 5 prevent pressure loss, but increase the likelihood of explosions.

FIG. 2 shows another conventional drain structure of a conventional high negative pressure exhaust system. A pipe with two manual valves 20a and 20b is connected to the depressed portion 3 of an exhaust pipe 1. According to the structure, the drain pipe must be periodically evaluated and maintained by draining solvents 5 therein. The described conventional drain structure, however, may increase the likelihood of explosions when a large amount of solvents or organic compounds are suddenly produced, caused by abnormal operations, leaks or breakdowns of semiconductor facilities.

Hence, there is a need for a better drain device for use in a high negative pressure exhaust system, capable of draining out condensed solvents and reducing the likelihood of explosions.

### SUMMARY OF THE INVENTION

Accordingly, an object of the invention is to provide a drain device for high negative pressure exhaust systems to remove or automatically drain condensed solvents from an exhaust pipe thereof.

The present invention provides a drain device for removing solvents condensed in a depressed portion of an exhaust pipe. The drain device comprises a drain pipe connected to the depressed portion of the exhaust pipe. A first gate and second gate are disposed in the drain pipe, forming a buffer space therebetween. The first gate is disposed adjacent to the inlet of the drain pipe. The needle valve communicates with the buffer space and the outlet, balancing pressure therebetween.

The drain pipe further comprises a partition between the first and second gates, partially obstructing the drain pipe. The flow rate of the needle valve is adjustable, so that only the first or second gate is open at one time. When a first amount of solvent accumulates in the depressed portion, the first gate opens briefly, allowing solvent to enter the buffer space. When a second amount of solvent accumulates in the buffer space, the second gate opens briefly, allowing solvent to drain from the outlet.

In a preferred embodiment, the first gate comprises a first cover with a first weight, for detecting when a first amount of liquid reaches a certain volume. The second gate comprises a second cover with a second weight, for detecting when a second amount of liquid reaches a certain volume.

The present invention also provides an exhaust system for exhausting liquid suspended in gas. The exhaust system comprises an exhaust pipe with a depressed portion and the previously described drain device. The drain pipe with an outlet and inlet is connected to the depressed portion. A first and second gate are disposed therein forming a buffer space therebetween. An adjustable needle valve communicated with the buffer space and the outlet, balancing pressure therebetween. When a first amount of solvent accumulates in the depressed portion, the first gate opens briefly, allowing solvent to enter the buffer space. When a second amount of solvent accumulates in the buffer space, the second gate opens briefly, allowing solvent to drain from the outlet.

### BRIEF DESCRIPTION OF THE DRAWINGS

The present invention can be more fully understood by reading the subsequent detailed description and examples with references made to the accompanying drawings which are given by way of illustration only, and thus are not limitation of the present invention, and wherein:

FIGS. 1 and 2 are schematic views of conventional drain structures.

FIG. 3 is a schematic view of a drain device system of the invention.

FIGS. 4A˜4E are schematic views of accumulated solvents automatically drained from the exhaust pipe.

FIG. 5A shows force applied to the cover of the first and second gates.

FIG. 5B is a timetable of each force applied to the first and second gates.

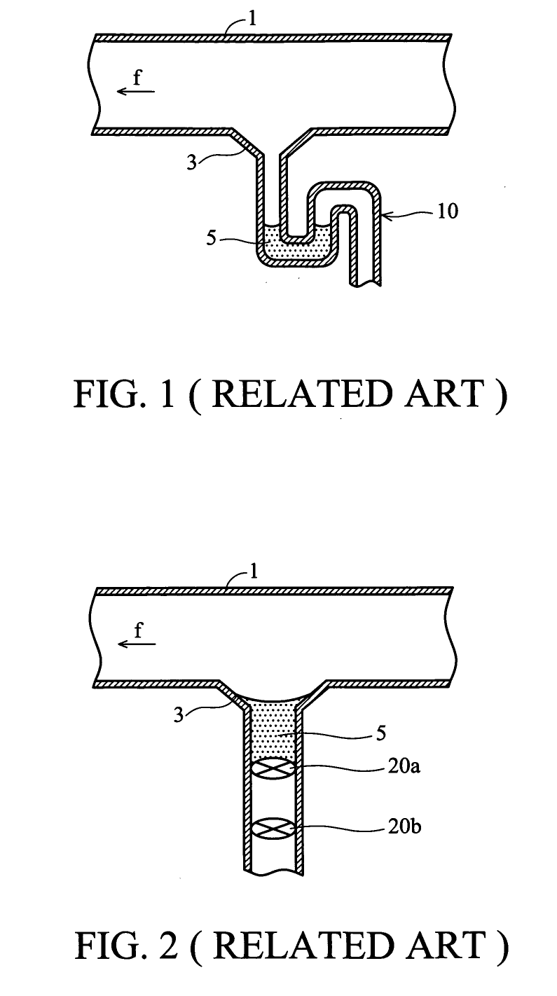

### DETAILED DESCRIPTION OF THE INVENTION

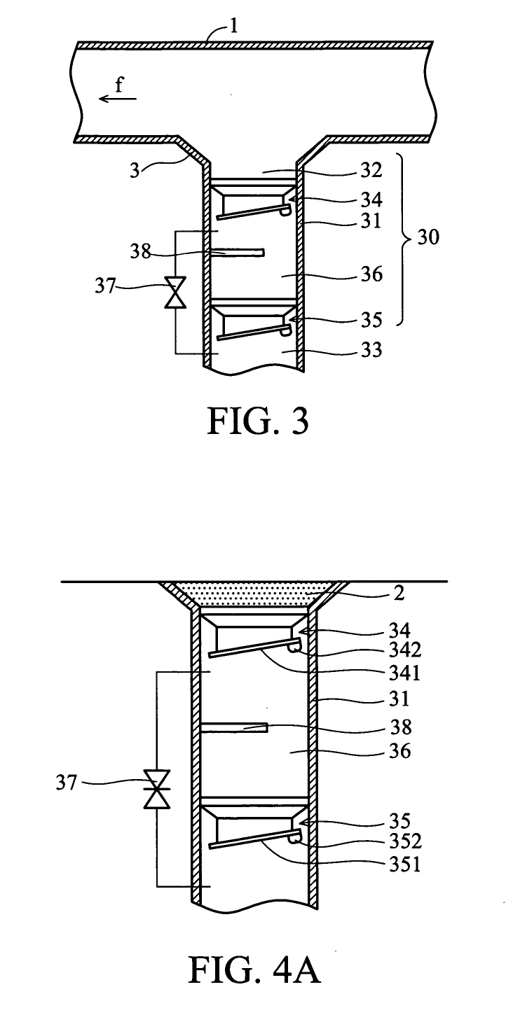

FIG. 3 shows a drain device 30 of the present invention. In FIG. 3, an exhaust pipe 1 with a depressed portion 3 is employed in a high negative pressure exhaust system. The symbol “f” represents the direction of the exhaust flow.

The drain device 30 of the present invention comprises a drain pipe 31 connected to the depressed portion 3 of the exhaust pipe 1 for draining condensed liquid or solvents accumulated therein. A first gate 34 and a second gate 35 are disposed in the drain pipe 31, separating the high negative pressure environment in the exhaust pipe 1 from the surrounding atmosphere. The first gate 34 is closed, blocking the inlet 32 of the drain pipe 31. The second gate 35 is downstream from the first gate 34, forming a buffer space 36 therebetween. The drain pipe 31 further comprises a partition 38 between the first and second gate 34, 35, partially obstructing the drain pipe 31, and an adjustable needle valve 37 communicated with the buffer space 36 and the outlet 33 of the drain pipe 31, for balancing pressure therebetween. When a first amount of solvent accumulates in the depressed portion 3, the first gate 34 opens briefly, allowing the solvent to enter the buffer space 36. When a second amount of solvent accumulates in the buffer space 36, the second gate 35 opens briefly, draining solvent from the outlet 33.

For example, the volume of the first amount of liquid may vary from about 5 cm³ to 50 cm³, and the volume of the second amount of liquid may vary from about 5 cm³ to 100 cm³. The first and second gate 34 and 35 can be adjusted so that only one is open at one time by means of preset weights, preventing pressure loss in the exhaust pipe 31. Furthermore, the open/close ratio between the first and second gate 34 and 35 is between 1:1 and 3:1, which is acceptable for risk control.

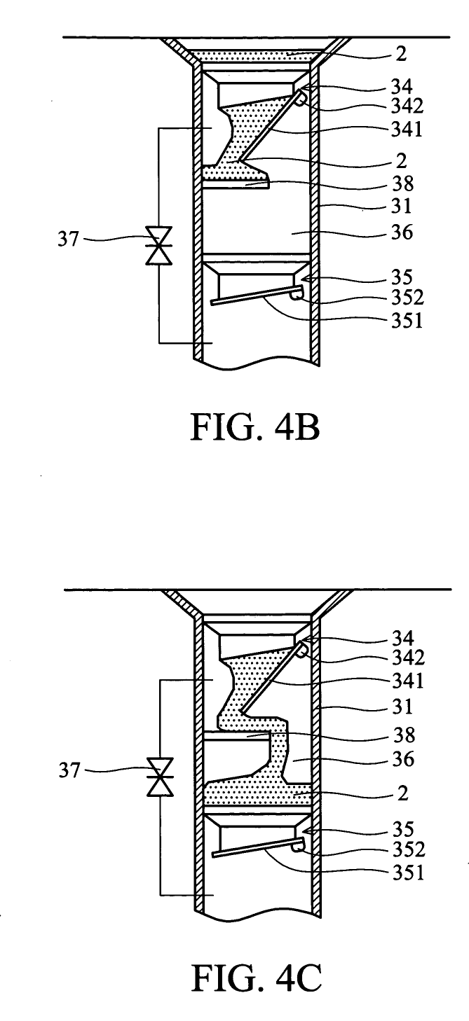

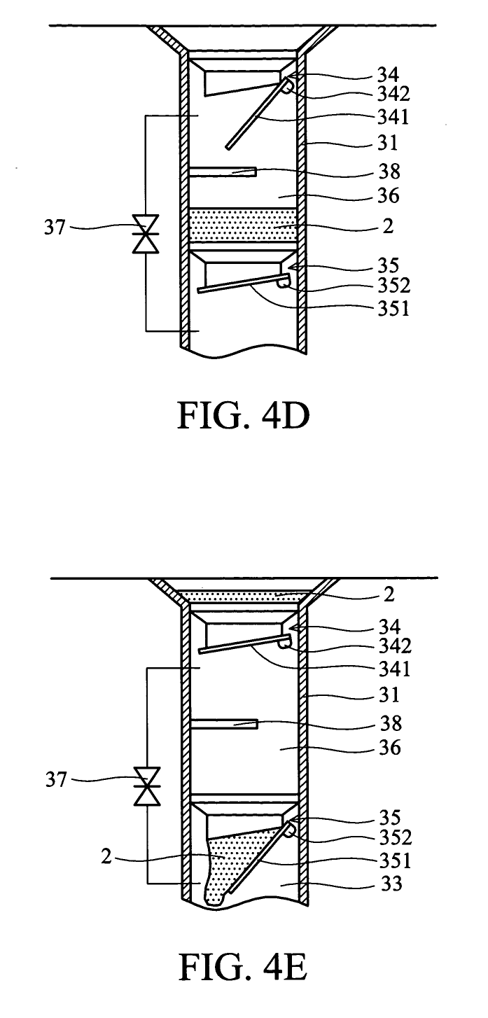

FIGS. 4A˜4E shows the steps of the drain device 30 automatically draining accumulated solvents from the exhaust pipe. In FIG. 4A, the first gate 34 comprises a body and a first cover 341 pivoted thereon. The first cover 341 comprises a first weight 342 for detecting the volume of the first amount of liquid. The second gate 35 also comprises a body and a second cover 351 pivoting thereon. The second cover 351 comprises a second weight 352 for detecting the volume of the second amount of liquid.

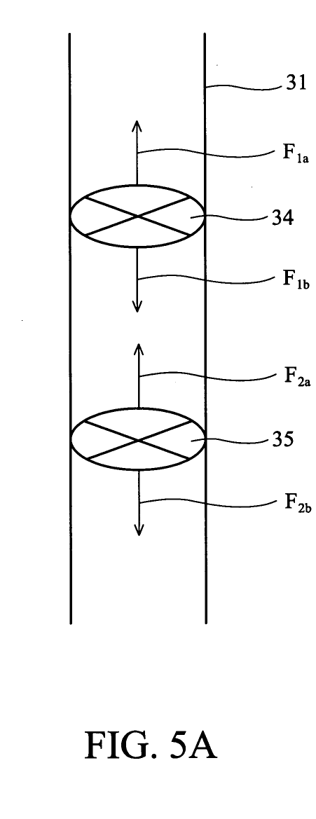

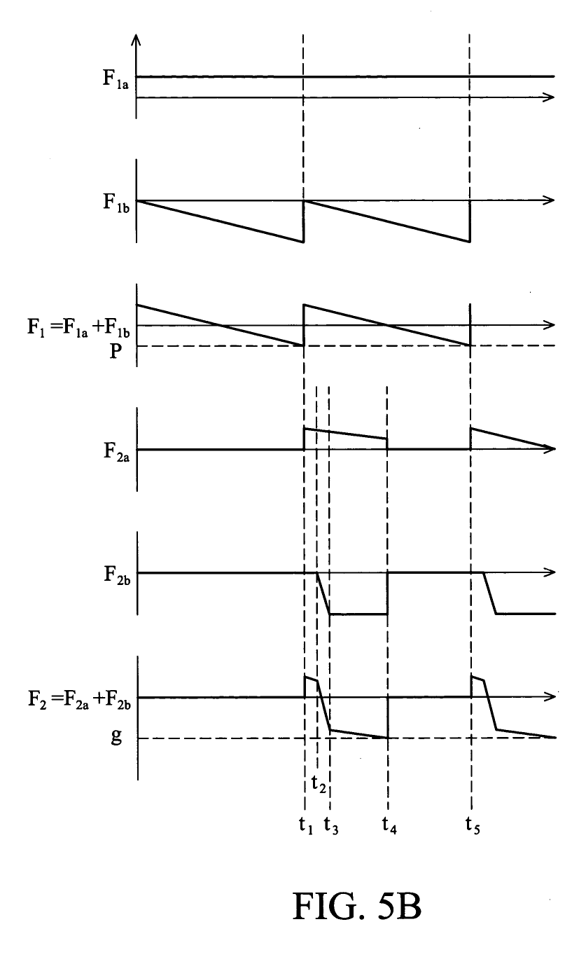

FIG. 5A shows force applied to the cover of the first and second gates, FIG. 5B is a timetable of a preferred embodiment. In order to simplify the description, the open/close ratio of the embodiment is 1:1.

In FIG. 5A, F₁ₐ represents a force applied to the first gate 34 generated by the pressure difference between the exhaust pipe 1 and the buffer space 36, F_{1b} represents the weight of solvent condensed on the first gate 34, and F₁ represents the resultant force thereof. F₂ₐ represents a force applied to the second gate 35 generated provided by the pressure difference between the buffer space 36 and the surrounding atmosphere, F_{2b} represents the weight of solvent condensed on the second gate 36, and F₂ represents the resultant force thereof. Furthermore, P and g in FIG. 5B represent the maximum downward force that the first and second gate 34 and 35 can bear. When the resultant force applied to the first and second gate 34 and 35 are larger than P and g, the first and second gate 34 and 35 open for draining the condensed solvent.

Referring to FIGS. 4A and 5B, the force F₁ₐ generated by the pressure difference between the exhaust pipe 1 and the buffer space 36 is maintain because the pressure in the negative pressure exhaust system nearly equal. As solvent 2 or water continuously condenses in the depressed portion 3 of the exhaust pipe 1, the force F_{1b} increases. When the resultant force F₁ on the first gate 34 meets the preset maximum downward force at t=t₁, the first cover 341 opens, directing solvent 2 into the buffer space 36. Simultaneously, the first cover 341 gradually returns to its original position due to the first weight 342 and the communication between the buffer space 36 and the exhaust pipe 1.

In FIG. 4B, the partition 38 in the buffer space 36 obstructs flow of the solvent 2, preventing sudden impact on the second gate 35, which may open the second gate 35 and cause pressure loss in the exhaust system.

In FIGS. 4C and 5B, the force F₂ₐ on the second gate 35 jumps increases rapidly due to the negative pressure in the exhaust pipe 1 and is gradually decreased by the needle valve 37. As the solvents 2 flow onto the second gate 35 at t=t₂, the downward force F_{2b} increases, reaching a maximum level at t=t₃ as shown in FIG. 5B. The resultant downward force F₂ applied to the second gate 35 is about g and gradually increases during t=t₃ to t=t₄.

In FIGS. 4E and 5B, the second cover 352 opens, draining solvents 2 from the drain pipe 31, when the resultant downward force F₂ equals to the preset maximum downward force g. The second cover 352 gradually returns to its original position as shown in FIG. 4A due to the second weight 352 and the communication between the buffer space 36 and the surrounding atmosphere.

The drain device of the present invention can automatically drain condensed solvents out of the exhaust pipe of a high negative pressure exhaust system. The open/close ratio of the gate can be tuned by means of the weights on the gates and the flow rate of the needle valve. Thus, the drain device of the present invention overcomes the disadvantages of conventional drain structures and is well suited for critical risk control purposes.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A drain device for removing liquid accumulated in a depressed portion of an exhaust pipe, comprising:
a drain pipe with an outlet and an inlet connected to the depressed portion;
a first gate disposed in the drain pipe near the inlet;
a second gate disposed in the drain pipe downstream from the first gate, forming a buffer space therebetween; and
a needle valve communicated with the buffer space and the outlet, balancing pressure therebetween.

2. The drain device as claimed in claim 1, wherein the drain pipe comprises a partition between the first and second gates, partially obstructing the drain pipe.

3. The drain device as claimed in claim 1, wherein the flow rate of the needle valve is adjustable.

4. The drain device as claimed in claim 1, wherein only the first or second gate is open at one time.

5. The drain device as claimed in claim 1, wherein when a first amount of liquid accumulates in the depressed portion, the first gate opens briefly, allowing liquid to enter the buffer space.

6. The drain device as claimed in claim 5, wherein the first gate comprises a first cover with a first weight for detecting the first amount of liquid.

7. The drain device as claimed in claim 5, wherein the drain pipe comprises a partition between the first and second gates, partially obstructing the drain pipe.

8. The drain device as claimed in claim 5, wherein the flow rate of the needle valve is adjustable.

9. The drain device as claimed in claim 5, wherein only the first or second gate is open at one time.

10. The drain device as claimed in claim 5, wherein when a volume of the second amount of liquid accumulates in the buffer space, the second gate opens briefly, allowing liquid to drain from the outlet.

11. The drain device as claimed in claim 10, wherein the second gate comprises a second cover with a second weight, detecting the second amount of liquid.

12. The drain device as claimed in claim 10, wherein the drain pipe comprises a partition between the first and second gates, partially obstructing the drain pipe.

13. The drain device as claimed in claim 10, wherein the flow rate of the needle valve is adjustable.

14. The drain device as claimed in claim 10, wherein only the first or second gate is open at one time.

15. A drain device for removing liquid accumulated in a depressed portion of an exhaust pipe, comprising:
a drain pipe with an outlet and an inlet connected to the depressed portion;
a first gate disposed in the drain pipe near the inlet; and
a second gate disposed in the drain pipe downstream from the first gate, forming a buffer space therebetween, wherein when a first amount of liquid accumulates in the depressed portion, the first gate opens briefly, allowing liquid to enter the buffer space, and when a second amount of liquid accumulates in the buffer space, the second gate opens briefly, allowing liquid to drain from the outlet.

16. The drain device as claimed in claim 15, wherein only the first or second gate is open at one time.

17. An exhaust system, for exhausting liquid suspended in gas, comprising:
an exhaust pipe with a depressed portion;
a drain pipe with an outlet and an inlet connected to the depressed portion;
a first gate disposed in the drain pipe near the inlet;
a second gate disposed in the drain pipe downstream from the first gate, forming a buffer space therebetween; and
a needle valve communicated with the buffer space and the outlet, balancing pressure therebetween.

18. The exhaust system as claimed in claim 17, wherein when a first amount of liquid accumulates in the depressed portion, the first gate opens briefly, allowing liquid to enter the buffer space, and when a second amount of liquid accumulates in the buffer space, the second gate opens briefly, allowing liquid to drain from the outlet.
